(19) United States
(12) Patent Application Publication
(10) Pub. No.: US 2008/0029449 A1
(43) Pub. Date: Feb. 7, 2008

(54) GRADED EXTERNAL PREFILTER ELEMENT FOR CONTINUOUS-FLOW SYSTEMS

(75) Inventors: Chris Dewaele, Nazareth (BE); Pascal Wijnant, Oudenaarde (BE); Hilde Surgeloose, Nazareth (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD LABORATORIES, INC., Hercules, CA (US)

(21) Appl. No.: 11/780,266

(22) Filed: Jul. 19, 2007

Related U.S. Application Data
(60) Provisional application No. 60/820,245, filed on Jul. 25, 2006.

(51) Int. Cl. B01D 35/30

(52) U.S. Cl. 210/232

(57) ABSTRACT

A prefilter element for continuous flow systems as illustrated by a high-performance liquid chromatography cartridge or column is constructed with a gradient filter that has a gradient in average pore size over its thickness, the pore size decreasing in the direction of flow. This prefilter element is retained in a housing separate from any functional components of the continuous-flow system other than the prefilter element itself, the prefilter element being separable from the other functional components to allow the prefilter to be replaced without disturbing any other functional components.

### CROSS-REFERENCE TO RELATED APPLICATION

This application claims benefit from U.S. Provisional Patent Application No. 60/820,245, filed Jul. 25, 2006, the contents of which are incorporated herein by reference in their entirety.

### BACKGROUND OF THE INVENTION

1. Field of the Invention

This invention relates to continuous-flow systems, including column chromatography, with particular interest to chromatography columns designed to separate components of sample mixtures that also contain solids or tend to form precipitates that lodge in the separation column or in prefilter media or otherwise interfere with the free flow of solutes through the column or cause the column back pressure to rise after a limited number of separations.

2. Description of the Prior Art

Continuous-flow systems, including high-performance liquid chromatography (HPLC) and other forms of chromatography, are widely used for analytical and preparative separations of mixtures of chemical species. The typical HPLC column, as an example, is used a multitude of times, particularly in automated chromatographic systems. The repeated use of a single column permits direct sample-to-sample comparisons without the error that is introduced by cleaning the separation medium between injections or by exchanging a used column for a fresh column of the same composition. During any single separation, however, it is common for solid debris, whether present in the sample or generated by the sampling or analytical equipment, to be entrained by the sample or the carrier fluid. In samples of lysed whole blood, for example, debris can consist of cell wall fragments, insoluble proteins, and soluble proteins that have agglomerated or precipitated. Debris can also originate in the chromatographic instrument itself, when valves and pump seals for example disintegrate and release particulate matter into the carrier fluid, or when fragments break off from a specimen tube or septum when the tube or septum is pierced by a sampling probe. The entrained debris often enters the column and accumulates in the column, obstructing the free flow of fluid through the column and causing back pressure in the column to rise.

The resin used as the separation medium in the HPLC column is typically held in place by frits which also act as filters for the solid debris. The frits themselves become clogged with the debris, however, particularly at the interface between the frit and the resin, again causing the column back pressure to rise. Clogging in the interfacial region also blocks the passage of very small proteinaceous material, thereby interfering with the separation when these proteins are among the components sought to be identified and/or quantified.

Debris accumulation and the resulting back-pressure build-up are of greatest concern in continuous-flow systems. In these systems, some of the debris can be removed off-line by filtration or centrifugation of a sample before the sample is injected into the system. Filtration and centrifugation are time-consuming steps, however, and an added source of operator error. Filtration can also be performed on-line by the use of guard columns and prefilters that are not in direct contact with the resin. One example of a prefilter that is designed for use on whole blood samples is a sintered stainless steel prefilter with a pore size of 0.5 micron and a thickness of 1.9 mm, available from Bio-Rad Laboratories, Inc., of Hercules, Calif., USA, Catalog No. 2700270. Unfortunately, prefilters are themselves susceptible to clogging and back-pressure build-up, for the same reasons. When guard columns are used, rising back pressure typically results in a need for replacement of the guard columns after 50 to 200 injections, depending on the application. When a prefilter is used as protection for a separatory resin, the resin can often survive longer intervals between replacements, but resin will still typically endure no more than 500 injections before replacement is needed.

An earlier disclosed approach to the back pressure build-up problem is described in Dewaele, U.S. Pat. No. 5,985,140, issued Nov. 16, 1999, entitled “Reduction in Back Pressure Buildup in Chromatography by Use of Graded Filter Media.” The graded filter in Pat. No. 5,985,140 is in direct contact with the resin in a common tube, however, and replacement of the filter requires dismantling of the resin tube, and often replacement of the resin as well as the filter.

### SUMMARY OF THE INVENTION

It has now been discovered that a graded filter medium can protect a chromatography column, analytical cartridge, or any component of a continuous-flow system when the graded filter medium is configured as an external protector of the system, rather than being coupled with other functional components of the system such as a separatory resin. By “functional components” is meant components that perform a function other than simply conveying the liquid from one location in the system to another. As an external protector, the graded filter medium can be removed and replaced when back pressure begins to rise, without disturbing the resin or other components of the continuous-flow system, and the graded filter medium can be firmly secured into its housing by mechanical tightening without the risk of damage to the resin or of causing resin particles to penetrate and commingle with the filter medium. The filter medium itself will thus require replacement less frequently and can be replaced more easily when replacement is needed. Further benefits are achieved when the graded filter medium is supported at the upstream end, downstream end, or both, by short lengths of non-graded filter media to serve as structural supports. Still further benefits are achieved in some cases when the graded filter medium is divided into two lengths or thicknesses, separated by a non-graded filter medium. In either case, non-graded filter media when present can provide, in addition to the support function, a filtering effect that supplements the filtering effect provided by the graded filter medium. In any of these configurations, the placement of graded filter medium in a housing that is external to the system or to the components that the filter is designed to protect will remove any debris from the sample flowing through the system, and can yet be used repeatedly on many more samples in succession without intervening cleaning steps than filters of the prior art.

### BRIEF DESCRIPTION OF THE DRAWINGS

FIG. 1 is an exploded view in perspective of a prefilter as one example of an implementation of the present invention.

FIG. 2 is an exploded view in perspective of a second prefilter as another example of an implementation of the present invention.

FIG. 3 is an exploded view in perspective of a third prefilter as still another example of an implementation of the present invention.

### DETAILED DESCRIPTION OF THE INVENTION AND PREFERRED EMBODIMENTS

As noted above, the gradient filter medium in the prefilter of this invention is arranged such that the sample fluid and any other liquids enter the medium through the side with the larger interstitial spaces, then pass through the medium and leave the medium through the side with the smaller interstitial spaces. When two layers of gradient media are present, both can be arranged for entry of the liquids through the side with the larger interstitial spaces and for exit through the side with the smaller interstitial spaces, or alternatively, the two gradient layers can be arranged with their gradients symmetrically arranged in opposite directions so that the prefilter can be mounted in either orientation relative to the direction of flow. In all cases when two or more gradient media layers are present, however, the upstream gradient medium layer will have a decreasing pore size in the direction of flow. In certain of these embodiments as well, the prefilter contains one or more porous elements that are similar to the gradient filter media except that their porosities are substantially uniform, i.e., lacking a gradient. These non-gradient porous elements are useful as structural supports for the gradient media, and can be present on the upstream side of the gradient media, the downstream side, or both, or in between two gradient media layers. Non-gradient porous elements can also be present in all three locations.

Although the degree and spatial rate of pore size gradation in gradient media within the scope of this invention can vary, as can the pore sizes themselves, the pore sizes in the gradient media are generally equal to or larger than those in any non-gradient porous elements that the gradient media are in contact with. In preferred embodiments, the ratio of the average pore diameter at the smallest-diameter end of each gradient layer to the average pore diameter in the non-gradient element is from about 1:1 to about 20: 1, more preferably from about 1:1 to about 12:1, and most preferably from about 1:1 to about 10:1. Best results will be obtained when the gradient layer, or each gradient layer when two or more are present, has a pore size gradation that decreases to an ultimate size that is narrow enough to retain particles that are 10 microns in diameter, preferably 5 microns in diameter, and most preferably 1 to 3 microns in diameter, although gradient layers capable of retaining particles on the order of 0.5 micron can also be used. Whether stated explicitly or not, references herein to pore diameters are references to pore diameters that are averaged over a given thickness or area, and the characterization of an element as having a uniform, or substantially uniform, pore size means that pore size distribution is substantially even or uniform over distance, volume or area, and hence the stated pore diameter is an average pore diameter. Thus, a gradient in pore diameter or interstitial space refers to a gradient in average pore diameter or average interstitial space.

Other relevant factors of the graded or non-graded element(s) of the prefilter are the thicknesses and permeability factors of the elements, both of which can vary as can the pore size. When one or more non-graded elements are present, they can be thicker (referring to the dimension in the direction of bulk sample flow) than the gradient layer(s) with which they are in contact. Preferred thicknesses are those in the range of about 0.5 mm to about 6.0 mm, most preferably about 1.0 mm to about 3.0 mm. Each gradient layer has a preferred thickness range of from about 0.1 mm to about 1.0 mm, preferably from about 0.2 mm to about 0.6 mm, and most preferably from about 0.3 mm to about 0.6 mm. The thickness ratio of each non-graded porous layer to each gradient layer is preferably from about 1:1 to about 30: 1, more preferably from about 1:1 to about 15:1, and most preferably from about 1:1 to about 10:1. The permeability factor k is defined by Darcy's Law:

$$\frac{Δ P}{L} = \frac{μ}{k} V$$

where ΔP is the pressure drop, L is the thickness of the filter, μ is the fluid viscosity, and V is the superficial velocity. The permeability factor of each gradient layer is preferably within the range of from about 4×10⁻¹³ to about 1×10⁻¹⁰, more preferably from about 4×10⁻¹³ to about 1×10⁻¹¹, and most preferably from about 4×10⁻¹³ to about 4×10⁻¹². A preferred range for the permeability factor of the non-graded porous element(s) is about 1×10⁻¹² to about 1×10⁻⁶, and a more preferred range is about 1×10⁻¹⁰ to about 1×10⁻⁸.

The gradation within each gradient layer may be stepwise or continuous, and the variation from the larger-pore side to the small-pore side may vary widely. The pore size differential (i.e., the difference between the largest pore size and the smallest pore size) may thus range from about 1 micron to about 50 microns, or preferably from about 2 microns to about 20 microns. When the gradations are stepwise, the gradient layer will contain two or more gradations, preferably three to six, and the pore size on the coarse (upstream) side of the layer (the coarsest portion of the layer) may range from about 2 microns to about 50 microns, preferably from about 2 microns to about 6 microns.

Each gradient filter element consists of sintered non-woven stainless steel fibers. The particular stainless steel is not critical to the invention, and a variety of different stainless steel alloys can be used. Austenitic stainless steels, i.e., those whose chief alloying elements are chromium and nickel, are preferred. A particularly preferred stainless steel is 31 6L stainless steel, whose composition is approximately 0.03% carbon, 2.00% manganese, 1.00% silicon, 16.0-18.0% chromium, 10.0-14.0% nickel, 0.45% phosphorus, 0.03% sulfur, and 2.0-3.0% molybdenum (all percents by weight). Examples of other useful stainless steels are 304, 304H, 304L, 304 LN, 316, 316F, 316H, 316LN, 316N, 317, 317L, 321, 321H, 347, 347H, 348, 348H, and 384.

A currently preferred filter medium that can be used as the gradient element(s) is BEKIPOR® ST filter medium, and in particular BEKIPOR® ST 3AL3, a product of NV Bekaert SA of Belgium, available through Bekaert Fibre Technologies Europe, Zwevegem, Belgium, and Bekaert Corporation, Atlanta, Ga., USA. This medium is made of 316L stainless steel fibers, randomly compressed in a non-woven structure and sintered, and is supplied in sheets, with typical lateral dimensions of 1180 mm×1500 mm and 0.4 mm in thickness. This particular product has an absolute filter rating of 3 microns, a bubble point pressure of 12,300 Pa (ASTM E 128061, equivalent ISO 4003), an average air permeability of 9 L/dm² /min at 200 Pa (NF A 95-352, equivalent ISO 4022), a permeability factor k of 4.80×10⁻¹³, a weight of 975 g/m², a porosity of 65%, and a dirt holding capacity of 6.40 mg/cm² according to Multipass method ISO 4572 with 8″ initial differential pressure. Other media of similar characteristics and made of similar materials can also be used.

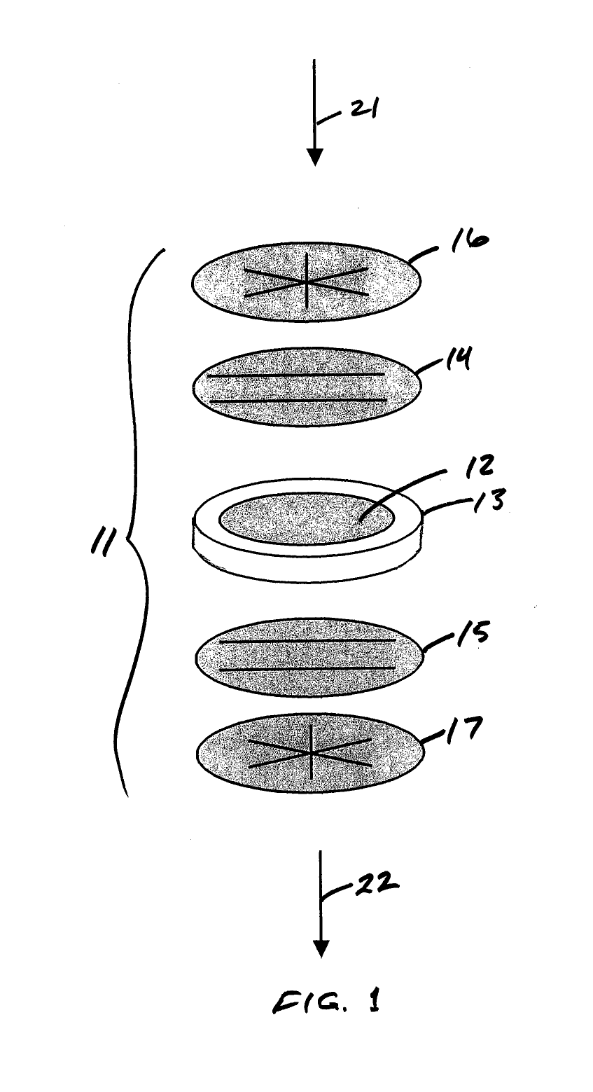

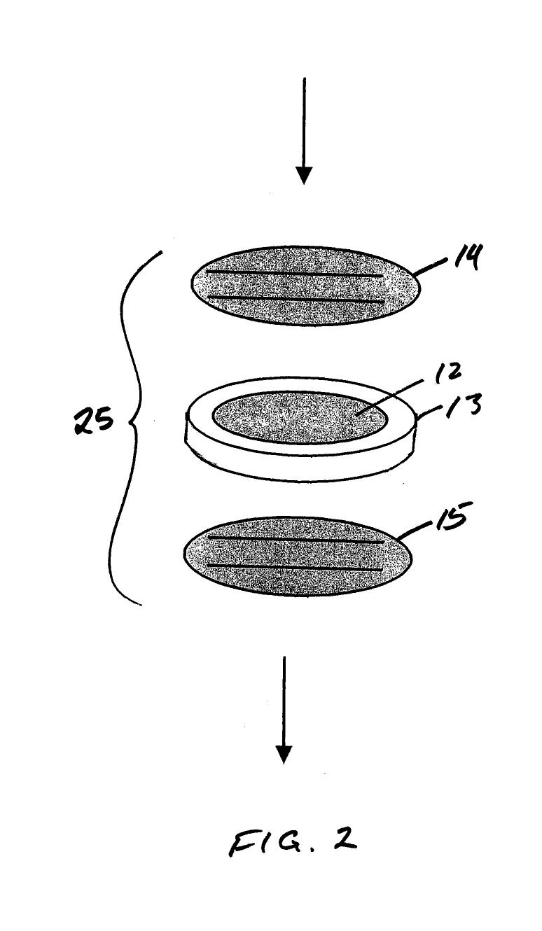

In certain prefilters in accordance with this invention, the gradient filter medium is in the form of two distinct layers combined with a non-graded porous layer in a sandwich-type prefilter that is arranged upstream of a cartridge or column used for HPLC or other forms of continuous-flow systems. In this sandwich-type prefilter, the gradient layers are layered over the non-graded porous element, i.e., a flat surface of each gradient layer is in full contact with a flat surface of the non-graded porous element. Sandwich-type prefilters of this description are illustrated in FIGS. 1 and 2. The prefilter 11 in FIG. 1 consists of a central porous element 12 of substantially uniform pore size, or evenly distributed pore sizes (i.e., non-graded), held in a supporting ring 13 which may be TEFLON®, TEFZEL®, or any other inert material that can form a fluid-tight seal, plus one gradient filter layer 14 on the upstream side of the non-graded element and a second gradient filter layer 15 on the downstream side of the non-graded element. Flow distribution disks 16, 17 are included in the prefilter housing next to the top and bottom outer surfaces of the prefilter sandwich. The direction of flow through the prefilter is indicated by the arrows 21, 22. The non-graded layer 12 in this embodiment is the sintered stainless steel element of Bio-Rad Laboratories, Inc., described above with a pore size of 0.5 micron, and a thickness of 1.9 mm. An alternative non-graded porous element is one with a pore size of 2.0 microns and the same thickness. The prefilter 25 in FIG. 2 is identical to that of FIG. 1 except that the flow distribution disks 16, 17 have been eliminated.

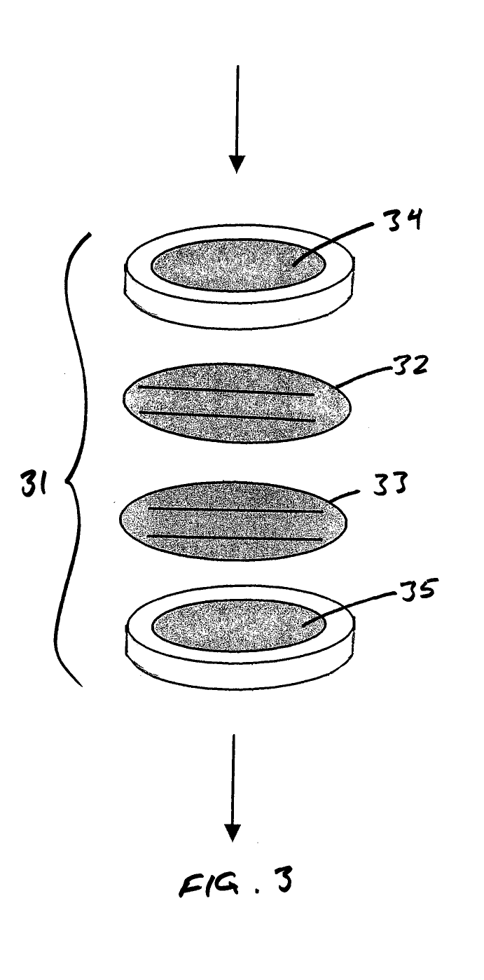

FIG. 3 depicts a sandwich-type prefilter 31 of a different arrangement, in which two gradient filter elements 32, 33 are included, and are placed adjacent each other in full contact. Non-graded porous elements 34, 35 are positioned at the upstream and downstream sides, respectively, of the combined gradient elements.

In each of the embodiments shown in FIGS. 1, 2, and 3, the upstream gradient element 14, 32 (i.e., the one nearest the top of each Figure) has a porosity gradient that proceeds from coarse to fine (a decreasing pore size) in the direction shown by the arrows. The downstream gradient element 15, 33 can either have a porosity gradient in the same direction so that both elements have pore sizes decreasing in the direction of flow, or a porosity gradient in the opposite direction permitting the entire sandwich structure to be inserted in the liquid flow path in either direction and avoiding the need for instructing the user to use the structure in one direction only.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein and an explicit teaching of this specification is intended to be resolved in favor of the teaching in this specification. This includes any discrepancy between an art-understood definition of a word or phrase and a definition explicitly provided in this specification of the same word or phrase.

The foregoing is offered for purposes of illustration. Further variations, modifications, and substitutions that fall within the scope of the invention will be readily apparent to those skilled in the art.

What is claimed is:

1. A prefilter for a continuous-flow system, said prefilter having a defined direction of flow of liquid therethrough and comprising a gradient filter element formed of sintered, non-woven stainless steel fibers of graded interstitial passages that form a gradient in size that decreases in said direction of flow, said gradient filter element residing in a housing separate from any functional components of said continuous-flow system other than said prefilter, said prefilter separable from said other functional components to permit replacement of said gradient filter element without disturbing said other functional components.

2. The prefilter of claim 1 wherein said gradient filter element is bounded on an upstream side relative to said direction of flow by a porous element containing pores whose average pore diameter is substantially uniform.

3. The prefilter of claim 1 wherein said gradient filter element is bounded on a downstream side relative to said direction of flow by a porous element containing pores whose average pore diameter is substantially uniform.

4. The prefilter of claim 1 wherein said gradient filter element is bounded on both upstream and downstream sides relative to said direction of flow by porous elements containing pores whose average pore diameter is substantially uniform.

5. The prefilter of claim 1 wherein said gradient filter element is defined as a first gradient filter element, said prefilter further comprising a second gradient filter element formed of sintered, non-woven stainless steel fibers of graded interstitial passages that form a gradient in size, both said first and second gradient filter elements residing in said housing, and said prefilter further comprising a porous element containing pores whose average pore diameter is substantially uniform, said porous filter element residing between said first and second filter elements in said direction of flow.

6. The prefilter element of claim 5 wherein said gradient in said second gradient filter element increases in size in said direction of flow.

7. The prefilter element of claim 5 wherein said gradient in said second gradient filter element decreases in size in said direction of flow.

8. The prefilter of claim 1 wherein said gradient filter element has a permeability factor of from about 4×10⁻¹³ to about 1×10⁻¹⁰.

9. The prefilter of claims 2 and 3 wherein said gradient filter element has a permeability factor of from about 4×10⁻¹³ to about 1×10⁻¹⁰, and said porous element has a permeability factor of from about 1×10⁻¹² to about 1×10⁻⁶.

10. The prefilter of claims 2 and 3 wherein said gradient filter element has a permeability factor of from about 4×10⁻¹³ to about 4×10⁻¹², and said porous element has a permeability factor of from about 1×10⁻¹⁰ to about 1×10⁻⁸.

11. The prefilter of claims 2 and 3 wherein said prefilter has a thickness ratio of said primary filter element to each of said first and second gradient filter elements of from about 1:1 to about 30:1.

12. The prefilter of claims 2 and 3 wherein said gradient filter element has a minimum pore diameter surface, and said prefilter has a ratio of average pore diameter of said minimum pore diameter surface to average pore diameter of said porous element of from about 1:1 to about 20:1.

13. The prefilter of claim 4 wherein said first and second gradient filter elements each have minimum pore diameter surfaces, and said prefilter has a ratio of average pore diameter of each of said minimum pore diameter surfaces of said first and second gradient filter elements to average pore diameter of said porous element of from about 1:1 to about 20:1.
